(19) United States
(12) Patent Application Publication
(10) Pub. No.: US 2010/0172241 A1
(43) Pub. Date: Jul. 8, 2010

(54) Method for IP network traffic management

(76) Inventor: Dipak V. Patel, Hoffman Estates, IL (US)

Correspondence Address: Alcatel-Lucent, Docket Administrator, Room 2F-192, 600-700 Mountain Ave., Murray Hill, NJ, 07974-0636, US

(21) Appl. No.: 12/319,447

(22) Filed: Jan. 6, 2009

(51) Int. Cl. H04J 1/16; G06F 15/173

(52) U.S. Cl. 370/235; 709/224

(57) ABSTRACT

To address the need for new techniques that can enable network traffic to be managed more effectively, various embodiments are provided. In general, communication network equipment receives (110, 210) a Session Initiation Protocol (SIP) request from an originator for routing to a destination. The network equipment then determines (120, 220) whether a traffic management condition is satisfied by the SIP request based on one or more prior SIP requests that satisfy a matching condition with the SIP request. When (130, 230) this traffic management condition is satisfied, the network equipment forwards the SIP request. Otherwise, it responds to indicate that the SIP request is blocked.

### FIELD OF THE INVENTION

The present invention relates generally to communication systems and, in particular, to IP (internet protocol) network traffic management.

### BACKGROUND OF THE INVENTION

At present, standards bodies such as 3GPP (3rd Generation Partnership Project) are developing standards specifications for systems that implement IMS (IP Multimedia Network System). (Detailed 3GPP information may be obtained via www.3gpp.org.) One problem that IMS-based networks face, which is not adequately addressed in existing IMS standards, is network overload. This problem can be particularly acute during high-attendance events (such as sporting events) or public safety emergencies. New techniques that can enable network traffic to be managed more effectively, and thereby prevent the service degradation that users experience during network overload, are clearly desirable.

### BRIEF DESCRIPTION OF THE DRAWINGS

FIG. 1 is a logic flow diagram of functionality performed by network equipment in accordance with various embodiments of the present invention.

FIG. 2 is a logic flow diagram of functionality performed by network equipment in accordance with various embodiments of the present invention.

FIG. 3 is a table depicting allow/block decisions for two different predefined allowance percentages (i.e., 70% and 20%) to illustrate how some specific embodiments of the present invention may operate.

FIG. 4 is a block diagram depiction of the processing of two Session Initiation Protocol (SIP) requests involving two IP Multimedia Network System (IMS) networks to illustrate an example of how some specific embodiments of the present invention may operate.

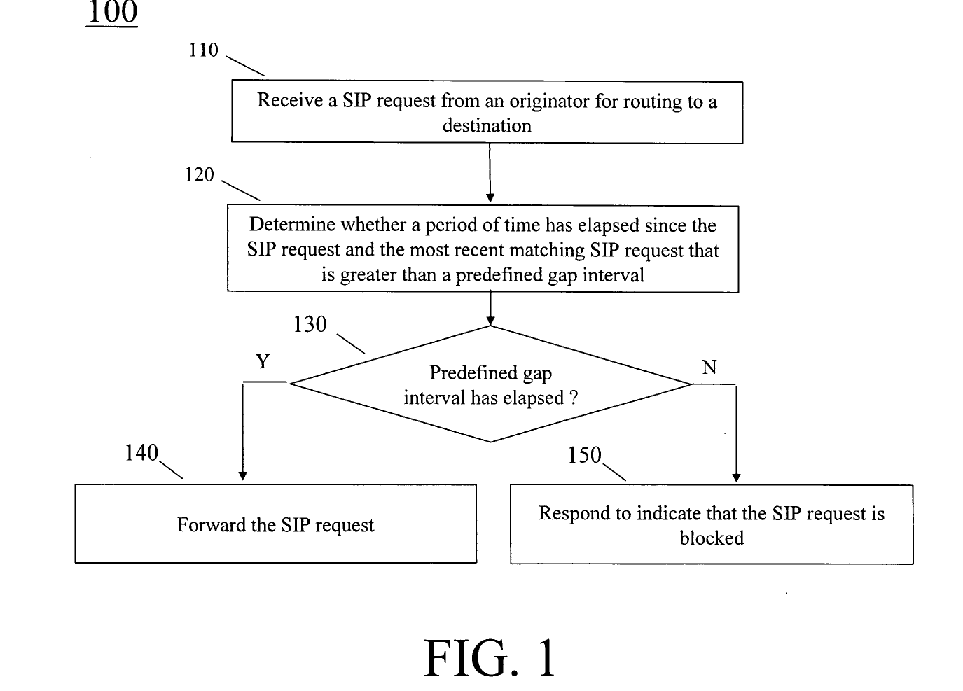

Specific embodiments of the present invention are disclosed below with reference to FIGS. 1-4. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

To address the need for new techniques that can enable network traffic to be managed more effectively, various embodiments are provided. In general, communication network equipment receives a Session Initiation Protocol (SIP) request from an originator for routing to a destination. The network equipment then determines whether a traffic management condition is satisfied by the SIP request based on one or more prior SIP requests that satisfy a matching condition with the SIP request. When this traffic management condition is satisfied, the network equipment forwards the SIP request. Otherwise, it responds to indicate that the SIP request is blocked.

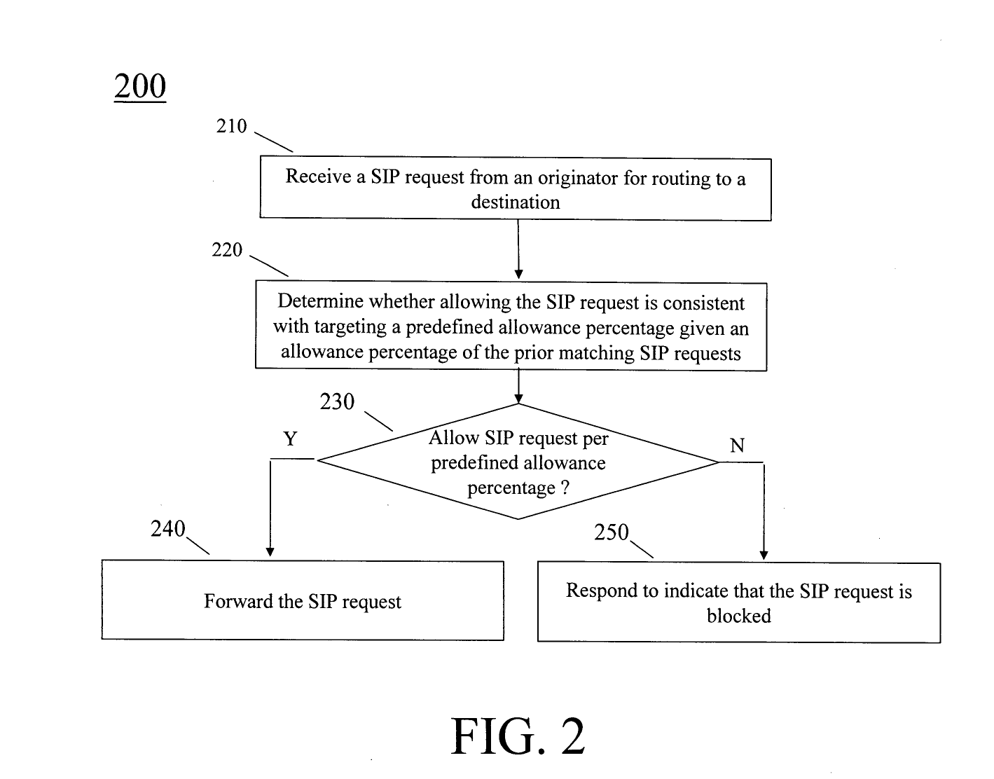

The present invention can be more fully understood with reference to FIGS. 1-4. FIGS. 1 and 2 are logic flow diagrams of functionality performed by network equipment in accordance with various embodiments of the present invention.

In logic flow 100, network equipment receives (110) a SIP request from an originator for routing to a destination. For example, this SIP request may be a SIP INVITE message. For traffic management purposes, the network equipment tracks, to some minimal extent at least, matching requests. Which requests are considered to match may depend on the embodiment and/or particular network operator settings. For example, an operator may want to control all the requests from the same originator or all the requests being routed to the same destination. In addition, the operator may want to define the originator and/or destination as a single address for matching purposes or a single network domain for matching purposes. By carefully defining the matching condition for requests to satisfy, a network operator may selectively focus the traffic management processing on those requests of particular concern to the network.

In the embodiments depicted by logic flow 100, the network equipment determines (120) whether a period of time has elapsed since the most recent matching SIP request that is greater than a predefined gap interval. In addition to the matching condition, the predefined gap interval may be a parameter adjusted by a network operator, further enabling a network operator to fine-tune the traffic management processing.

If (130) a period of time at least as great as the predefined gap interval has elapsed since the most recent matching SIP request, further processing of the present SIP request is allowed and the request is forwarded (140) as it otherwise would be. However, if instead the predefined gap interval has not yet elapsed, then the SIP request is blocked for traffic management purposes and a response (150) is sent indicating that the request has been blocked. For example, a SIP message that indicates that the SIP request cannot be serviced at this time may be returned to the originator. Upon receiving such a response, the originator may then initiate a new request to try to obtain service or wait, perhaps not trying again until the present burst in traffic subsides. Either way, the feedback, particularly if received by a user, can provide a greater quality of service than a request that simply times out or network service that is degraded due to network overload.

In the embodiments depicted by logic flow 200, network equipment receives (210) a SIP request from an originator for routing to a destination. The network equipment determines (220) whether allowing the SIP request is consistent with targeting a predefined allowance percentage given an allowance percentage of the prior matching SIP requests. As described above with respect to logic flow 100, the network operator may define the matching condition that is used for identifying which prior requests are matching requests for traffic management purposes.

In addition to the matching condition, the predefined allowance percentage may also be a parameter adjusted by a network operator. Thus, if the predefined allowance percentage is set to 70%, for example, the network equipment may determine whether allowing the SIP request will cause an allowance percentage for the SIP request and prior SIP requests to exceed 70%.

If (230) allowing the SIP request is consistent with targeting the predefined allowance percentage, further processing of the present SIP request is allowed and the request is forwarded (240) as it otherwise would be. However, if instead allowing the SIP request is not consistent with targeting the predefined allowance percentage, then the SIP request is blocked for traffic management purposes and a response (250) is sent indicating that the request has been blocked. For example, a SIP message that indicates that the SIP request cannot be serviced at this time may be returned to the originator.

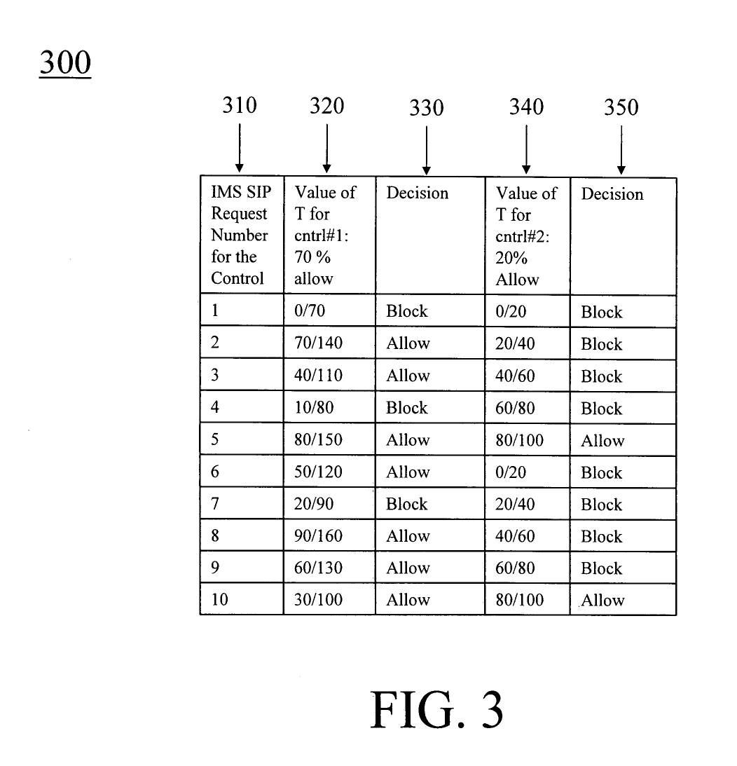

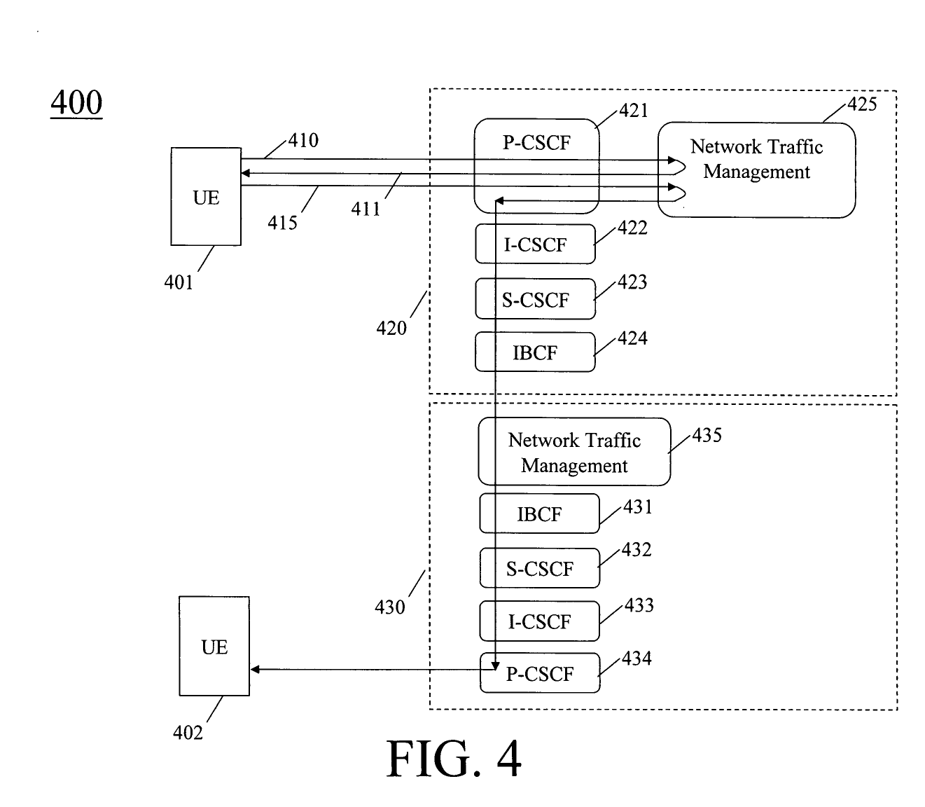

To provide a greater degree of detail in making and using various aspects of the present invention, a description of certain, quite specific, embodiments follows for the sake of example. FIGS. 3 and 4 are referenced in an attempt to illustrate some examples of how some specific embodiments of the present invention may operate.

In a first specific embodiment, IMS SIP Request Gapping controls limit the number of SIP request attempts routed to the specified destination or being originated by a specific user or network. Gap interval or control limits are defined in milliseconds for a given control (control is data for the specific user or destination, perhaps identified by telephone number, user name, host name, etc.) by the operator and provided to gapping software which will enforce a minimum time between requests. Dynamic data to store the time stamp for the last matching request are created for all controls. When control matching criteria is satisfied, the current time in milliseconds is generated using the operating system functions and compared against the stored time in the dynamic data. The request will be allowed if the time difference between the previous matching request and the current matching request is greater than the gap interval defined by the operator.

When the current time in milliseconds minus the previous time stored in dynamic data for that control is less than the gap interval defined by the operator, the SIP request is blocked by sending a proper SIP response. Otherwise, the current time is recorded in the dynamic data for that control, since this request is being allowed. The following pseudo code captures this method:

```
    if ((current time − previous time) > gap interval
for this control)
    {
        // Allow calls and set the time to current
            time in dynamic data table.
        IMS_NTM_TABLE[control_id − 1 ].gap_time =
        current time (in ms)
    }
    else
    {
        Block the request by sending proper SIP
            response message.
    }
```

In a second specific embodiment, IMS SIP Code Blocking works by using percentage-based criteria to allow or reject a given IMS SIP Request. Such code blocking controls the downstream traffic by only allowing a predefined percentage of requests for the user to originate or be routed to the specific destination. The percentage allowed can be defined by the operator based on the known traffic pattern or based on an upcoming event. Following pseudo code captures the method:

```
Integer T represent the temporary number with
    initial value of zero
Let A be the percentage allowed for the given
    control (i.e., user)
    T += A;
        if (T >= 100)
        {
            Allow the Request
            T −= 100;
        }
        else
        {
            Block the Request
        }
```

FIG. 3 is a table depicting allow/block decisions for two different predefined allowance percentages (i.e., 70% and 20%) to illustrate how this specific embodiment of the present invention operates. For a given control, column 310 records requests 1-10. For a predefined allowance percentage of 70%, column 320 records the value of T (from the pseudo code above) for each request and column 330 the corresponding allow/block decision. For a predefined allowance percentage of 20%, column 340 records the value of T (from the pseudo code above) for each request and column 350 the corresponding decision.

FIG. 4 is a block diagram depiction of the processing of two Session Initiation Protocol (SIP) requests involving two IP Multimedia Network System (IMS) networks to illustrate an example of how some specific embodiments of the present invention may operate. As depicted in FIG. 4, system 400 includes two UEs 401 and 402 serviced by two different IMS networks 420 and 430. Each IMS network is depicted as including known functional network entities such as Proxy Call Session Control Functions (P-CSCFs) 421 and 434, Interrogating Call Session Control Functions (I-CSCFs) 422 and 433, Serving Call Session Control Functions (S-CSCFs) 423 and 432, and Interconnections Border Control Functions (IBCFs) 424 and 431.

Typically, these IMS functions are performed by network equipment comprising one or more application servers. Likewise, network traffic management functions 425 and 435 may also be performed by such network equipment. In some embodiments, network traffic management functions 425 and 435 may each be incorporated into one or more of the other IMS functions 421-424 and 431-434, respectively. For example, network traffic management function 425 may be incorporated into P-CSCF 421 and/or be performed by an application server that is serving as P-CSCF 421. In another example, network traffic management function 435 may be incorporated into IBCF 431 and/or be performed by an application server that is serving as IBCF 431.

FIG. 4 also depicts the processing of two SIP requests 410 and 415, to illustrate an example. In the case of SIP request 410, it is received by the network equipment performing the network traffic management function 425. Depending on the embodiment, network traffic management functions 425 and 435 may each perform methods such as those described with respect to logic flows 200 and/or 300 in which an allow or block decision is made for requests.

Thus, in the case of SIP request 410, for the purpose of illustration, a blocking decision is made by traffic management function 425 resulting in SIP response 411 (e.g., SIP response 411 may be a SIP_TEMP_NOT_AVAILABLE 480 message). In the case of SIP request 415, for the purpose of illustration, an allowing decision is made by traffic management function 425 resulting in the SIP request being forwarded on to IMS network 430. Again for the purpose of illustration, an allowing decision is made by traffic management function 435 resulting in the SIP request being forwarded on through IMS network 430.

FIG. 4 depicts the processing of two SIP requests, one allowed and one blocked, and the independent traffic management functions within each IMS network. Clearly, not every IMS network may employ such traffic management functions, nor is an IMS network necessarily limited to just one such traffic management function.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

The present invention may also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for IP (internet protocol) network traffic management comprising:
receiving a Session Initiation Protocol (SIP) request from an originator for routing to a destination;
determining whether a traffic management condition is satisfied by the SIP request based on at least one prior SIP request that satisfies a matching condition with the SIP request;
when the traffic management condition is satisfied, forwarding the SIP request;
when the traffic management condition is not satisfied, responding to indicate that the SIP request is blocked.

2. The method as recited in claim 1, wherein the matching condition between the SIP request and the at least one prior SIP request is satisfied when the SIP request and the at least one prior SIP request have the same originator.

3. The method as recited in claim 2, wherein the originator comprises a single network address.

4. The method as recited in claim 2, wherein the originator comprises a network domain.

5. The method as recited in claim 1, wherein the matching condition between the SIP request and the at least one prior SIP request is satisfied when the SIP request and the at least one prior SIP request have the same destination.

6. The method as recited in claim 5, wherein the destination comprises a single network address.

7. The method as recited in claim 5, wherein the destination comprises a network domain.

8. The method as recited in claim 1, wherein the traffic management condition is satisfied by the SIP request when a period of time has elapsed since the most recent SIP request of the at least one prior SIP request that is greater than a predefined gap interval.

9. The method as recited in claim 8, wherein the predefined gap interval is an operator-adjustable parameter.

10. The method as recited in claim 1, wherein the traffic management condition is satisfied by the SIP request when allowing the SIP request will not cause an allowance percentage for the SIP request and prior SIP requests to exceed a predefined allowance percentage.

11. The method as recited in claim 1, wherein determining whether the traffic management condition is satisfied by the SIP request based on the at least one prior SIP request that satisfies the matching condition with the SIP request comprises
determining whether allowing the SIP request is consistent with targeting a predefined allowance percentage given an allowance percentage of the prior SIP requests.

12. The method as recited in claim 11, wherein the predefined allowance percentage is an operator-adjustable parameter.

13. The method as recited in claim 1, wherein determining whether the traffic management condition is satisfied by the SIP request comprises
determining, by an application server performing an IP Multimedia Network System (IMS) Proxy Call Session Control Function (P-CSCF), whether the traffic management condition is satisfied by the SIP request.

14. The method as recited in claim 1, wherein determining whether the traffic management condition is satisfied by the SIP request comprises
determining, by an application server performing an IP Multimedia Network System (IMS) Interrogating Call Session Control Function (I-CSCF), whether the traffic management condition is satisfied by the SIP request.

15. The method as recited in claim 1, wherein determining whether the traffic management condition is satisfied by the SIP request comprises
determining, by an application server performing an IP Multimedia Network System (IMS) Interconnections Border Control Function (IBCF), whether the traffic management condition is satisfied by the SIP request.

16. The method as recited in claim 1, wherein receiving the SIP request comprises
receiving the SIP request via another IP Multimedia Network System (IMS) network.

17. The method as recited in claim 1, wherein receiving the SIP request comprises
receiving a SIP INVITE message.

18. The method as recited in claim 1, wherein responding to indicate that the SIP request is blocked comprises
responding with a SIP message that indicates that the SIP request cannot be serviced at this time.
